(19) United States
(12) Patent Application Publication
(10) Pub. No.: US 2018/0330013 A1
(43) Pub. Date: Nov. 15, 2018

(54) GRAPH DATA STORE FOR INTELLIGENT SCHEDULING AND PLANNING

(71) Applicant: Microsoft Technology Licensing, LLC, Redmond, WA (US)

(72) Inventors: Lars H. Liden, Seattle, WA (US); Justin Cranshaw, Seattle, WA (US)

(21) Appl. No.: 15/593,743

(22) Filed: May 12, 2017

(51) Int. Cl. G06F 17/30; G06Q 10/10

(52) U.S. Cl. CPC G06F 17/30979; G06Q 10/1095

(57) ABSTRACT

A computer-implemented method and system for intelligent scheduling and planning includes storing scheduling and/or planning information in a plurality of nodes and a plurality of edges of a graph data store, wherein a node includes properties representing an entity including a person, activity, or location, and the edges include properties representing relationships among persons, relationships among persons and activities, and edges between activities and activity instances. The graph data store is queried to assist in scheduling and/or planning an activity performed by a person, the querying producing scheduling and/or planning information representative of relationships among the nodes. The scheduling and/or planning information is analyzed to generate a scheduling and/or planning opportunity for a person or group of persons. The scheduling and/or planning opportunities are presented or displayed to a person or group of persons, and input is received from at least one person regarding the scheduling and/or planning opportunity. In one embodiment, depending on the input received, an entry is added to an electronic calendar based on the scheduling and/or planning opportunity.

### BACKGROUND

In today's fast paced business, family and personal lives, time is a precious commodity, and often in short supply. Moreover, with so much information to digest each and every day, if not minute, it's increasing difficult to stay abreast of, or even spend much time thinking about, business or personal opportunities for recreation or professional development. As a result, in this age of tight schedules and ubiquitous information, many people would appreciate any help they can get with scheduling and planning. While some existing personal information management systems provide features to assist a user in scheduling, such as providing visibility into other user's schedules and the ability to send electronic invitations for meetings, features such as these still leave much of the task of scheduling to the user. Moreover, while such system may provide tools to keep track of tasks of dates for planning purposes, they too leave the actual planning of tasks to perform and dates to perform them by, to the user.

### SUMMARY

Various details for the embodiments of the inventive subject matter are provided in the accompanying drawings and in the detailed description text below. It will be understood that the following section provides summarized examples of some of these embodiments.

According to one embodiment, there is provided a graph data store for storing scheduling and planning information and providing virtual scheduling and/or planning assistant services, including storing scheduling and/or planning information in a plurality of nodes and a plurality of edges of a graph data store, wherein nodes include properties representing entities including persons, activities, and activity instances, and edges include properties representing relationships among persons, activities, and activity instances. The graph data store is queried to assist in scheduling and/or planning an activity performed by a person, and the querying produces scheduling and/or planning information representative of relationships among the entities represented by the nodes. The information is electronically processed and analyzed to generate a scheduling or planning opportunity for a person or group of persons, and the opportunity is displayed to a person or group of persons. Input is received regarding the opportunity, and, in one embodiment, an entry regarding the opportunity is added to a personal information manager, or otherwise communicated to a user. According to one additional example embodiment, there are further included nodes representing location entities, and scheduling and/or planning opportunities include a location. In another embodiment, scheduling and planning information is gathered and selectively added to the data store by a process that includes, for example, monitoring of electronic data resources, such as cloud-based resources including but not limited to personal information management systems and on-line sources of event information, and a processing and analysis process, that analyzes and transforms gathered data.

An embodiment discussed herein includes a computing device including processing hardware (e.g., a processor) and memory hardware (e.g., a storage device or volatile memory) including instructions embodied thereon, such that the instructions, which when executed by the processing hardware, cause the computing device to implement, perform, or coordinate electronic operations in accordance with the electronic systems and processes described herein. Another embodiment discussed herein includes a computer program product, such as may be embodied by a machine-readable medium or other storage device, which provides the instructions to implement, perform, or coordinate electronic operations. Another embodiment discussed herein includes a method operable on processing hardware of the computing device, to implement, perform, or coordinate electronic operations.

As discussed herein, the logic, commands, or instructions that implement aspects of the electronic operations described above, may be provided in a client computing system or a server computing system, including any number of form factors for the computing system such as desktop or notebook personal computers, mobile devices such as tablets, netbooks, and smartphones, client terminals and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described above, or other aspects depicted in the accompanying drawings and detailed description below.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1A illustrates an embodiment of a computer-implemented intelligent scheduling and planning system, according to an example.

FIG. 1B illustrates an embodiment of a relational data structure for an intelligent scheduling and planning system, according to an example.

FIG. 1C illustrates an embodiment of a graph data structure for an intelligent scheduling and planning system, according to an example.

FIG. 2A illustrates software components of an intelligent scheduling and planning application, according to an example.

FIG. 2B illustrates computer-implemented functionality of an intelligent scheduling and planning engine, according to an example.

FIG. 2C illustrates an automated data gathering component, according to an example.

FIG. 2D illustrates an automated data gathering diagram, according to an example.

FIG. 2E illustrates a process to assist in generating a scheduling and/or planning opportunity, according to an example.

FIG. 3 illustrates relationships between person entities, according to an example.

FIG. 4 illustrates relationships between person entities and activity entities, according to an example.

FIG. 5 illustrates relationships between a person entity and an activity instance entity, according to an example.

FIG. 6 illustrates relationships among activity instance entities and locations for the activity instance entities, according to an example.

FIG. 7 illustrates relationships between a group of person entities and activity instance entities, according to an example.

FIG. 8 illustrates a flowchart of a process to gather scheduling and/or planning data from an electronic calendar, to load into a data store, according to an example.

FIG. 9 illustrates a flowchart of a process to gather scheduling and/or planning data from a mobile application, to load into a data store, according to an example.

FIG. 10 illustrates a flowchart of a process to gather scheduling and/or planning data from a person's task list or e-mail, according to an example.

FIG. 11 illustrates a flowchart of a process to gather scheduling and/or planning data by scanning the Internet or other data sources, to load into a data store, according to an example.

FIG. 12 illustrates a flowchart of a process to gather scheduling and/or planning data by correlating a person's location and a person's calendar, to load into a data store, according to an example.

FIG. 13 illustrates a flowchart of a process to gather scheduling and/or planning data by receiving explicit input from users or persons, to load into a data store, according to an example.

FIG. 14 illustrates a flowchart of a process to analyze scheduling and/or planning information to provide virtual scheduling and/or planning assistance, according to an example.

FIG. 15 illustrates a flowchart of a process for virtual scheduling and/or planning that provides scheduling and/or planning assistance to a user or for one or more persons, according to an example.

FIG. 16 illustrates a flowchart of a process to proactively suggests persons, activities, and/or tasks to a user for scheduling and/or planning purposes, according to an example.

FIG. 17 illustrates a flowchart of a process for a virtual scheduling and/or planning assistant that responds to different types or requests, according to an example.

FIG. 18 illustrates a block diagram of hardware and functional components of client and server computing systems to implement operations that identify and utilize clusters of user interaction commands, according to an example.

FIG. 19 is a block diagram illustrating components of a machine able to read instructions from a machine-readable medium and perform any of the methodologies discussed herein, according to an example embodiment.

### DETAILED DESCRIPTION

In the following description, methods, configurations, and related apparatuses are disclosed for storing, querying and/or processing and analyzing scheduling and planning related information to provide automated scheduling and planning capabilities, according to example embodiments. These embodiments variously provide technical advantages in gathering, storing, managing, querying, processing and analyzing scheduling and planning related information, to provide more efficient and enhanced capabilities described herein. As used herein, the terms “data” and “information”, used in the context of being stored in the data store 101 and/or electronically processed, are used interchangeably and are representative of knowledge, or representative of values.

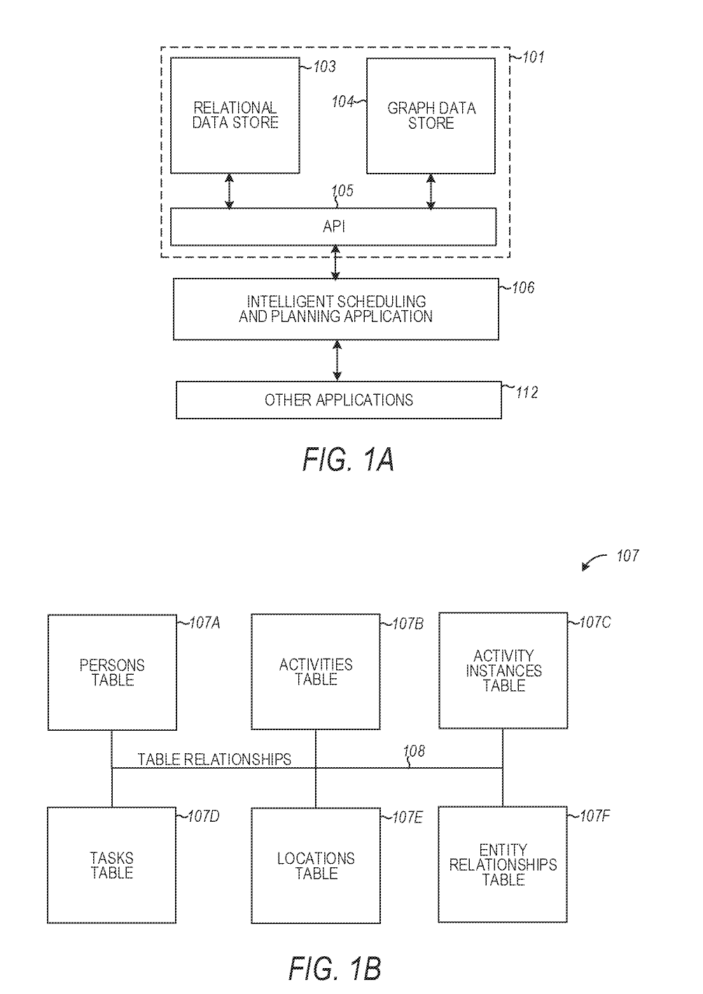

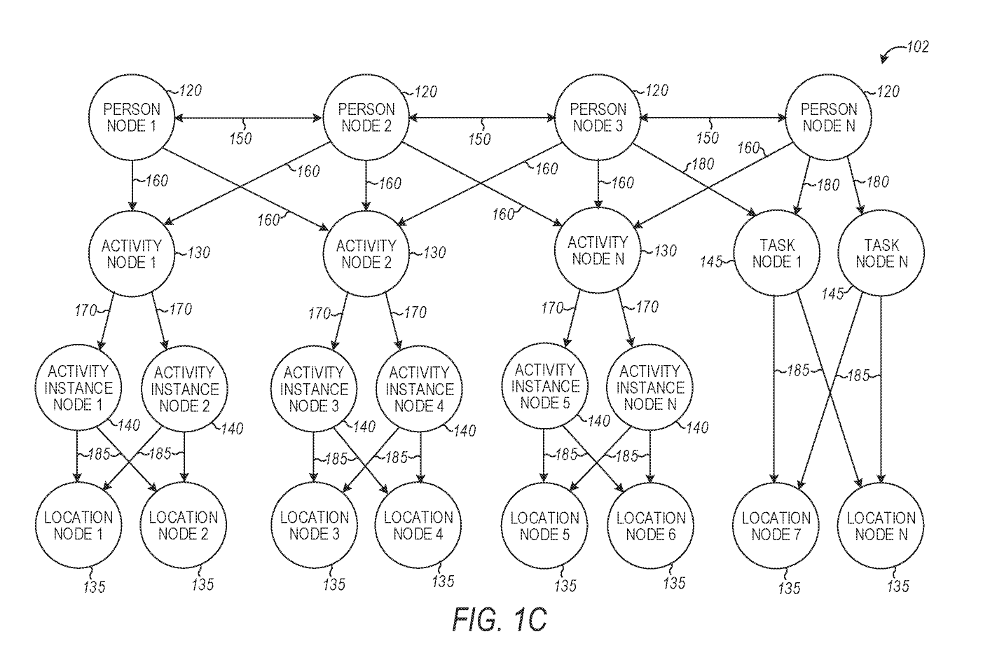

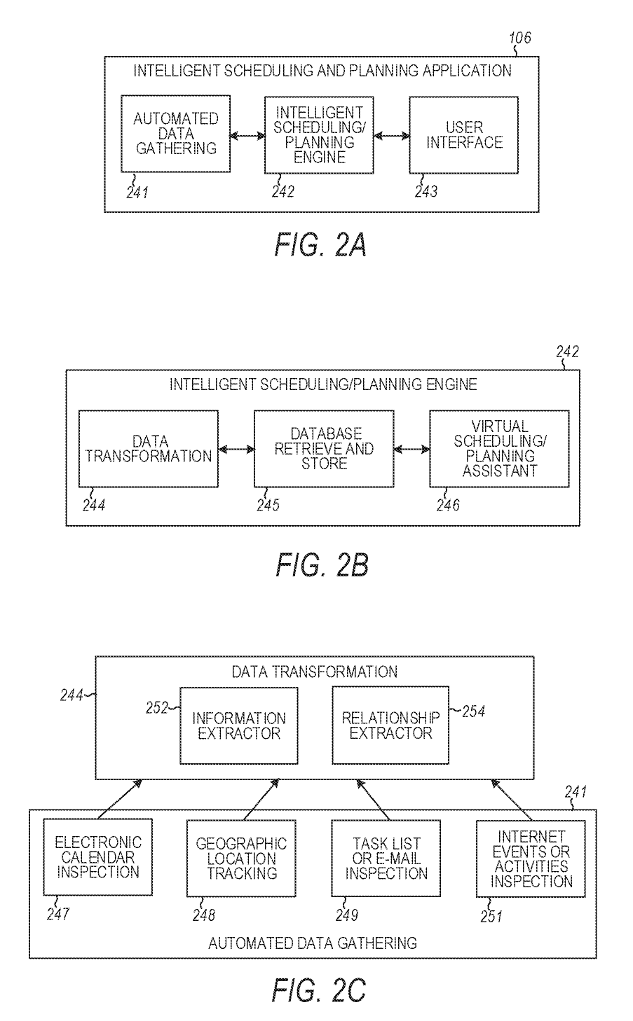

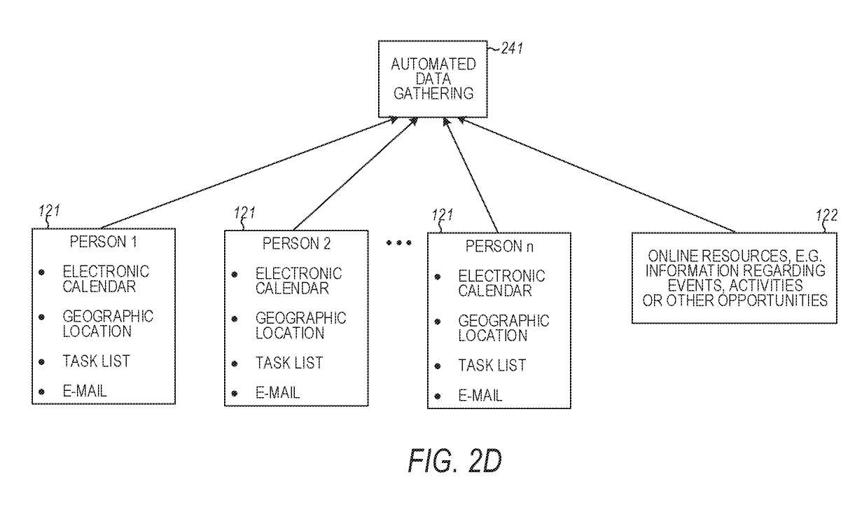

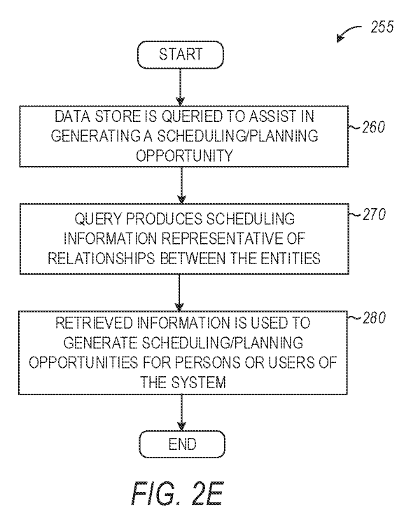

Referring now to FIG. 1A, FIG. 1B, FIG. 1C, FIG. 2A, FIG. 2B, FIG. 2C, FIG. 2D and FIG. 2E, there is illustrated a first example embodiment of a computer-implemented intelligent scheduling and planning system 100. As shown in the example embodiment of FIG. 1A, system 100 includes a data store 101 for storage and retrieval of information related to scheduling and/or planning, and an intelligent scheduling and planning application 106, that operates to perform various electronic functions describe herein, including but not limited to storing information in, and retrieving information from, data store 101, analyze and/or examine the retrieved data, and to gather, process and analyze scheduling and planning information to add to the data store 101. Data store 101 may be of any type, but according to one example embodiment, data store 101 is a relational data store 103. In another example embodiment, data store is a graph data store 104. In another embodiment, data store 101 includes both a relational data store 103 and graph data store 104 to store and structure information, and to make it accessible to electronic processes. Further, in an example embodiment, the relational data store 103 and graph data store 104 are accessed through an application programming interface (API) 105.

In one example embodiment, data store 101 stores information concerning a plurality of entities related to scheduling and/or planning, including but not limited to, person, activity, and activity instance entities. In another example embodiment, data store 101 additionally stores information related to location and/or task entities. Data store 101 further stores information concerning relationships among these entities. Such relationships, in one example embodiment, include, but are not limited to, information concerning relationships among persons, relationships among persons and activities, activity instances and/or tasks, relationships among activities and activity instances, and relationships of locations among persons, activities, activity instances and/or tasks. Examples of information stored regarding such relationships, are given herein below.

According to one example embodiment illustrated in the simplified diagram of FIG. 1B, relational data store 103 has a relational database structure based on a relational data model, with data stored in tables 107 that are related to one another, for example but not by way of limitation, through keys and relationships 108. In one embodiment, entities are stored in corresponding tables, with rows of the respective tables representing instances of the entities. For example, in one embodiment there is provided a Person Table 107a that includes rows representing individual persons. Similarly, Activities Table 107b includes a rows for individual activities, and activity instances table 107c includes rows for instances of activities. Further, if included, Tasks Table 107d includes rows for individual tasks, and a Locations Table 107e includes rows for locations. Further, relational data store 103 includes one or more Entity Relationships Tables 107f with rows holding information concerning relationships among entities represented in the database, including relationships among persons, relationships among persons and activities, and relationships among activities and activity instances. According to one example embodiment, Entity Relationships Tables 107f store relationship information concerning the relationships among tasks and locations and other entities, such as the relationship of an activity instance to a location.

Using the keys and other relationships defined between the tables, as will be understood by those of skill in the relational database art, the entity and relationship information, stored in the tables of the data store 103, are queried in order to provide or ascertain relationships among the entities such as people, activities and activity instances, and use the relationships to assist in intelligent scheduling and/or planning, as will be described further hereinbelow. According to another example embodiment, an implementation based on a relational data store uses a structured query language (SQL) to retrieve data from the relational data store 103.

According to another example embodiment illustrated in FIG. 1C, graph data store 104 uses a graph structure 102, with nodes, edges and properties to represent and store data. The relationships allow data in the store to be linked together directly with edges, and in many cases retrieved with one operation. In graph data store 104, nodes comprise data representing entities, and edges connect nodes to other nodes, and comprise data that represents the relationship among the nodes. Data representing the node entities and the edge relationships are stored, for example, as properties. According to one embodiment, nodes of the graph data store 104 represent entities including, but not limited to, persons, activities or activity instances. According to another example embodiment, entities include tasks and/or locations. The edges include properties about relationships among entities represented by the nodes of the data store, including but not limited to, relationships among persons, relationships among persons and activities, and relationships among activities and activity instances. In the case tasks and/or locations are included, an edge represents the relationship of a task to a person or location, or the relationship of an activity instance to a location, or other relationships. According to another example embodiment, other scheduling and/or planning related nodes are added as additional nodes of the graph data store 104, and additional edges are included to store relationships among these additional nodes and the previously described nodes.

According to one example embodiment, the edges of the graph data store 104 provide for connecting two nodes of the data store. According to this embodiment, a graph include a set of nodes N={n1, n2, . . . , nn} and a set of edges E={e1, e2, . . . , em} where each e in E is a connections between a pair of nodes, e={ni, nj}. According to another example embodiment, the graph data store 104 is a hypergraph data store wherein edges can connect more than two nodes. For example, in this example embodiment, the hypergraph data store includes a set of nodes N={n1, n2, . . . , nn} and a set of edges E={e1, e2, . . . , em} where one or more of Edges E can connect more than two nodes. For example an edge e1 connects nodes n1, n4, and n6, or an edge e6 connects nodes n4, n8, n12, and n14. As used herein below, the symbol “←→” represents and edge between entities specified to the left and right of the symbol.

More specifically, according to one embodiment, illustrated in FIG. 1C, the graph data store 104 includes a plurality of Person Nodes 120 each including properties of a person, Activity Nodes 130 each including properties of an activity, Location Nodes 135 each including properties of a location, and Activity Instance Nodes 140 each including properties of an activity instance. Edges connect the nodes wherein an Person←→Person Edge 150 among Person Nodes 120 includes properties about a relationship among persons identified by Person Nodes 120, an Person←→Activity Edge 160 between a Person Node 120 and an Activity Node 130 includes properties about the relationship between a person and an activity, and an Activity←→Activity Instance Edge 170 between an Activity Node 130 and an Activity Instance Node 140 links activities to activity instances. In the case task entities and Task Nodes 145 are included, a Person←→Task Edge 180 represents the relationship of a Task Node 145 to a Person Node 120, and Edges 185, the relationships of Activity Nodes and Task Nodes to Location Nodes 135.

According to one example embodiment, the underlying storage mechanism of the graph data store 104 takes different forms. In one example embodiment, graph data store 104 is implemented using a relational engine such as relational data store 103, with graph data stored in tables, or in a key-value store, or document-oriented database, an inherently NoSQL structure. According to another example embodiment, an implementation based on a non-relational storage engine includes tags or properties, that allow data elements to be categorized for easy retrieval en masse. According to another example embodiment, retrieving data from a graph data store 104 is performed with semantic queries, for example using a NoSQL query language, such as but not limited to query languages like Gremlin®, SPARQL®, and Cypher®.

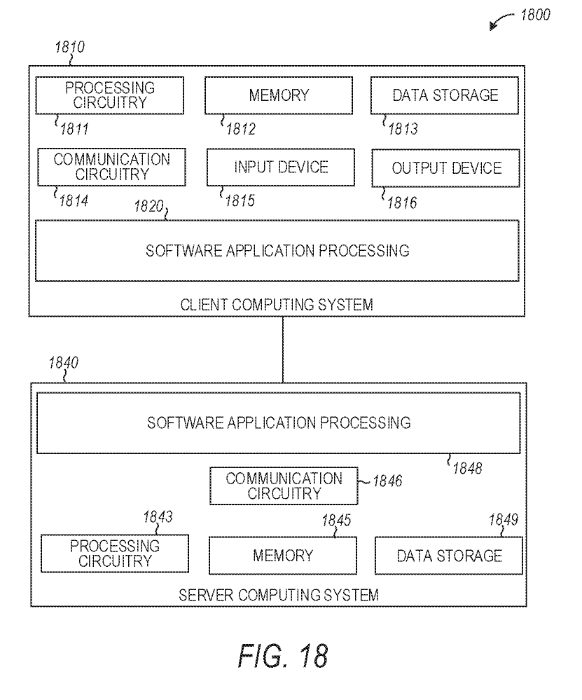

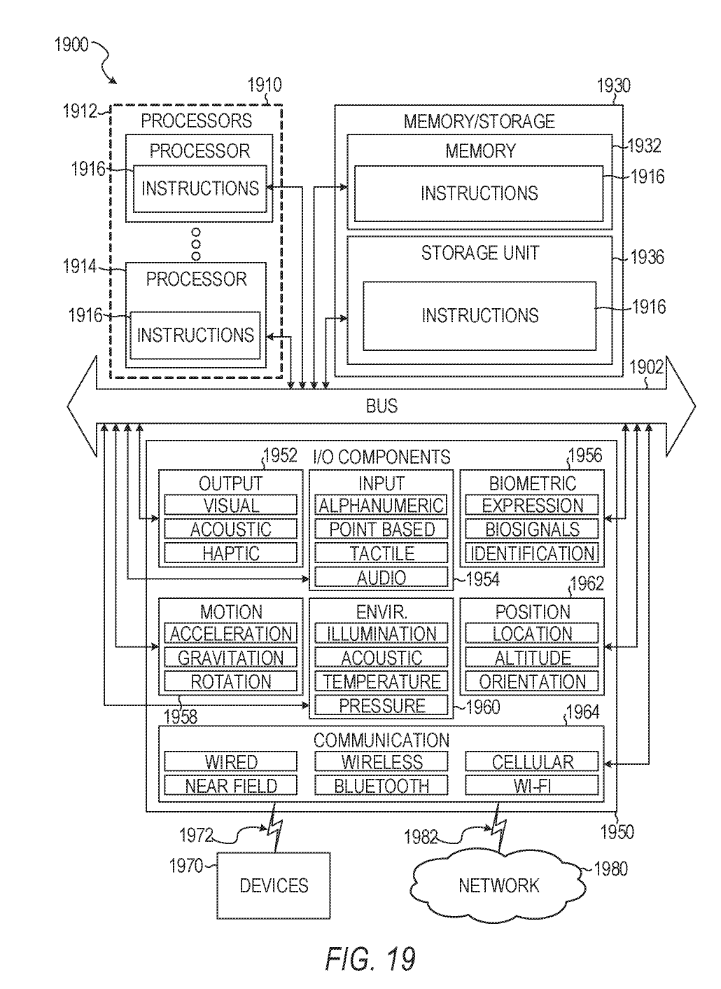

According to an example embodiment, an intelligent scheduling and planning application 106, illustrated in FIG. 1A and FIG. 2A, operates to gather information for, and store and retrieve information from, data store 101, and more specifically, relational data store 103 and/or graph data store 104, and further to analyze and/or examine the retrieved data in order to generate scheduling and/or planning opportunities. Further, optionally, application 106 interacts with or is integrated with one or more other applications 112, such as but not limited to, a bot, a social media application or platform, or an electronic calendaring system. An application 112, includes, in one example embodiment, a user interface that displays an electronic representation of schedule or planning related information to a user, or receives input concerning the same or for other purposes, from a user. According to one example embodiment, intelligent scheduling and planning application 106 and application(s) 112 operate across client and server computing systems, such as described below with respect to FIG. 18 and FIG. 19, in a client-server mode of operation.

In one example embodiment, application 112 is an personal information management system, such as the Microsoft® Outlook® system available from Microsoft Corporation, allowing calendar and task information is displayed in various different views, such as daily, monthly or yearly views, and allows the user to perform one or more of the following functions: add calendar appointments or meetings on a specific date and/or time, or series of dates and/or times, electronically invite others to participate in the appointment or meetings, receive and accept or decline electronic requests to participate in other individual's appointments or meetings, add locations for appointments or meetings, add tasks to the calendar to perform, or receive an electronic request to perform a task for another individual, and accept or decline that request, and perform other functions common to today's electronic calendaring systems.

As illustrated in FIG. 2A, intelligent scheduling and planning application 106, in one example embodiment, includes an automated data gathering component 241, an intelligent scheduling and planning engine 242, and a user interface component 243. According to other example embodiments described in more detail below, automated data gathering component 241 gathers or receives schedule and planning related data from various sources, and more particularly, for example, from electronic or machine-readable data sources or repositories, such as those illustrated in FIG. 2E. The gathered schedule and planning related data is processed and analyzed by intelligent scheduling and planning engine 242, which in turn uses the data and information derived from the data, to populate scheduling and/or planning information in the data store 101, and in particular the tables of relational data store 103 and the nodes and edges of the graph data store 104. Intelligent scheduling and planning engine 242 further provides for processing and analyzing information in data store 101 to automatically generate scheduling and/or planning opportunities. A user interface component 243 of intelligent scheduling and planning application 106 provides for receiving information and commands from, and communicating information to, a user of the intelligent scheduling and planning application 106. In one embodiment, information is communicated by electronically sending or presenting the information to another application, which may in turn display it to a user, or by presenting the information to a user visually, for example in a graphical user interface.

Referring now to FIG. 2B, there is illustrated in more detail an example embodiment of the intelligent scheduling and planning engine 242, which includes a data transformation component 244 to process, analyze and/or transform schedule and planning related data obtained by data gathering component 241, a database input-output component 245, and a virtual scheduling and planning assistant 246. According to one embodiment, the data transformation component 244 performs the processes described below, to analyze schedule and/or planning data gathered by automated data gathering component 241. According to another embodiment, database input-output component 245 retrieves and stores information in the data store 101, such as relational data store 103 and graph data store 104. According to still another embodiment, the virtual scheduling and planning assistant 246 performs the functions described in greater detail below, to provide scheduling and/or planning assistance to users.

Referring now to FIG. 2C, there is illustrated an example embodiment of automated data gathering component 241 that gathers machine-readable information from a plurality of electronic data sources or repositories, and provides the data to transformation component 244 that processes the information in order to ascertain entities, relationships between the entities, and other information, and to store this information, or update information already in, data store 101. Component 241 includes, in this example, a personal information management inspection component, and components to mine other data sources. In one embodiment, component 241 includes, more specifically, an electronic calendar inspection component 247, a geographic location tracking component 248, a task list or e-mail inspection component 249, and an Internet events or activities inspection component 251. These components, described further below, gather and collect scheduling and planning related information from various on-line, Internet or other electronic data sources or repositories, to assist in populating the graph data store 104.

As illustrated in FIG. 2D, there is illustrated a simplified diagram of one embodiment of the operation of the automated data gathering component 241. Component 241, in this example, gathers and/or collects information from one or more electronic calendars or electronic task lists, and/or e-mail accounts of a person 121 represented in data store 101, for example by a Person Table 107a or by a respective Person Node 120, and/or, tracks the geographic location of the person 121, using geographic location information, for example obtained from a smart phone or other device used by the respective person 121. In addition, in another example embodiment, component 241 also gathers and/or collects information from on-line resources 122, for example information about upcoming events or activities that may be of interest to a person 121.

As further illustrated in FIG. 2C, the schedule and planning related data gathered by component 241, for example as described above, is processed and transformed by data transformation component 244, so that information extracted or derived therefrom can be stored in data store 101, and more particularly in the relational data store 103, in data fields and tables, or graph data store 104, as graph properties for entities or relationships represented by nodes and edges. According to one example embodiment, data transformation component 244 includes an information extractor 252 and a relationship extractor 254. According to one embodiment of a process illustrated in FIG. 2E, data or information in an unstructured format, such as alphanumeric content in the body of an e-mail, is processed to extract structured information, for example lists of entities that are mentioned, frequencies of mention of these entities, and/or sentiment of the mentions, for example, whether the entities were mentioned in a positive or negative way, by a person or group of persons. In addition, expressions of times and dates are also extracted by information extractor 253.

According to one example embodiment of a process to extract information, the information extractor 252 automatically extracts structured information from machine-readable, unstructured information (information that either does not have a pre-defined data model or is not organized in a pre-defined manner) and/or semi-structured information. According to one embodiment, this information extraction is performed on human language texts using natural language processing. In another embodiment, information extraction performed by information extractor 252 is performed on multimedia documents, including but not limited to, automatic annotation and content extraction out of images, audio and/or video content. In one embodiment of a process, a named entity extracted by information extractor 252 is a person, activity, activity instance, location, task and/or other entity, represented in the data store 101. According to still another example embodiment of a process, information extractor 252 and/or relationship extractor 254 uses one or more of the following systems or methods to perform information extraction such as that described above: neural networks, word embeddings, conditional random fields, linguistic inquiry and word count, and/or structured learning. However, other systems and methods may also be used, and the inventive subject matter is in no way limited in this regard.

According to another example embodiment of a process, relationship extractor 254 inspects and analyzes data received into data transformation component 244 in order to determine relationships between entities, such as relationships among and between persons, activities, activity instances, tasks, locations, or other entities. According to another example embodiment of a process, the relationship extractor 254 determines a relationship between a person and an activity, activity instance, location or task, by inspecting a person's electronic personal information manager, for instance to determine what activities, and instances of those activities, the person or persons have entered in their respective electronic calendars, and/or determine what tasks the person or persons have performed in the past, and/or determine locations and/or days and/or times the activities, activity instances, and/or tasks have been performed by a person or persons. According to another example embodiment of a process, relationships extractor 254 inspects a person's electronic personal information manager to determine, for a person, other persons that the person has participated in activities, activity instances and/or tasks with, based on persons invited to an activity on the person's electronic calendar, such as meeting, appointment, event or task. In another example embodiment of a process, relationships between persons are determined by inspecting the “to” or “from” addressees on e-mails between persons, to ascertain which persons are sending and receiving e-mails from each other. In another embodiment of a process, the person, activity, activity instances, tasks or location entities extracted from the text of an e-mail body are correlated with persons, activities, activity instances, tasks and/or locations, to ascertain relationships between such entities. Such relationships, in one embodiment, are determined with reference to only information gathered by data gathering component 241, and/or is determined with reference to both information gathered by data gathering component 241 and entity and relationship information previously stored in data store 101.

According to another example embodiment of a process, relationship extractor 254 performs sentiment analysis (sometimes known as opinion mining or emotion artificial intelligence) using natural language processing, text analysis, computational linguistics, and biometrics to systematically identify, extract, quantify, and otherwise interpret affective states, and in particular the sentiment of persons toward other persons, activities, activity instances, locations and/or task entities represented in the data store 101.

As illustrated in FIG. 2E, there is illustrated an example embodiment of process 255, for example performed by intelligent scheduling and planning application 106 and/or application(s) 112, wherein the data store 101 is queried 260 to assist in generating a scheduling and/or planning opportunity for an activity performed by a person, wherein the querying produces scheduling and/or planning information 270 representative of relationships among nodes. As will be described further herein below, this retrieved information is electronically processed and analyzed in order to automatically generate scheduling and/or planning opportunities 280 for persons or users of the scheduling and planning system.

According to one example embodiment, queries 260 are carried out periodically, or upon demand, and the frequency is set by a person using the system. In one example embodiment of a process, each person sets a preference about how frequently they want to check for opportunities for each relationship and/or time/date. For example, for each edge in the graph 104, there is a schedule or clock that determines the frequency at which the query process is run, in order to determine a planning and/or scheduling opportunity.

According to one example embodiment of process 255, a scheduling and/or planning opportunity is added to the data store 101 as a relationship property, e.g., to the relationship table of relational data store 103 or and edge of graph store 104, that has not yet been added to a person's calendar or task-list. In one embodiment, as process 255 continues to mine relationships in the data store 101, and adding information to it, process 255 determines whether a new piece of knowledge in the data store 101 that represents an opportunity for scheduling and/or planning, should be recommended to a user. If it is, the opportunity is thus recommended to a person through any of the means described herein elsewhere, for example through user interface 243. In one example embodiment, process 255 learns a “score” for the likelihood that a particular person is going to accept the suggestion, based, for example, on historical data, and/or on explicit preferences specified by a user. In this manner, when process 255 mines a new relationship, and adds it to the data store 101, for example either in a relationship table of data store 103 or an edge of data store 104, process 255 determines whether or not to share this new relationship, with a particular person.

As used herein, the term “person” means an individual that is represented by a row of table 107a of relational data store 103, or a Person Node 120 of the graph data store 104. As used herein, the term “user” means an individual interacting with the scheduling and planning system described herein, wherein the user is either a person represented in the data store 101, or not. The term “scheduling and planning information” means information required for or pertaining to arranging or planning something, for example an appointment that may or may not take place at a particular time, and/or to pursue an opportunity that does not necessarily require a particular place and time in order to be achieved. As used herein, the term “property” means information germane to an entity or row in a table of the relational data store 103, or a node in graph data store 104, and/or a relationship among entities, and rows or nodes. As used herein the terms “links” or “edges” means a connection or relationship created by an edge of the graph data store 104. As used herein, the term “between” means between two entities, or between more than two entities. As used herein, the term “activity” means a thing that a person or group does such as a specific deed or action, and the term “task” means a piece of work to be done or undertaken. For example, an activity includes but is not limited to activity watching movies, working out, skiing, eating out, going to a bar, and climbing. As used herein, an “activity instance” means a particular one, species or sub-type of an activity, such a particular movie genre, a particular theatre location, a particular type of work out, a particular gym, a particular ski resort, a particular restaurant, a particular food, a particular bar, a particular beverage, and a particular climbing venue. For another example, tasks include but are not limited to such chores as cleaning the gutters, filing a patent, doing math homework, or getting groceries. According to other examples, locations include residences, work places, parks, conference rooms, museums, bars and restaurants.

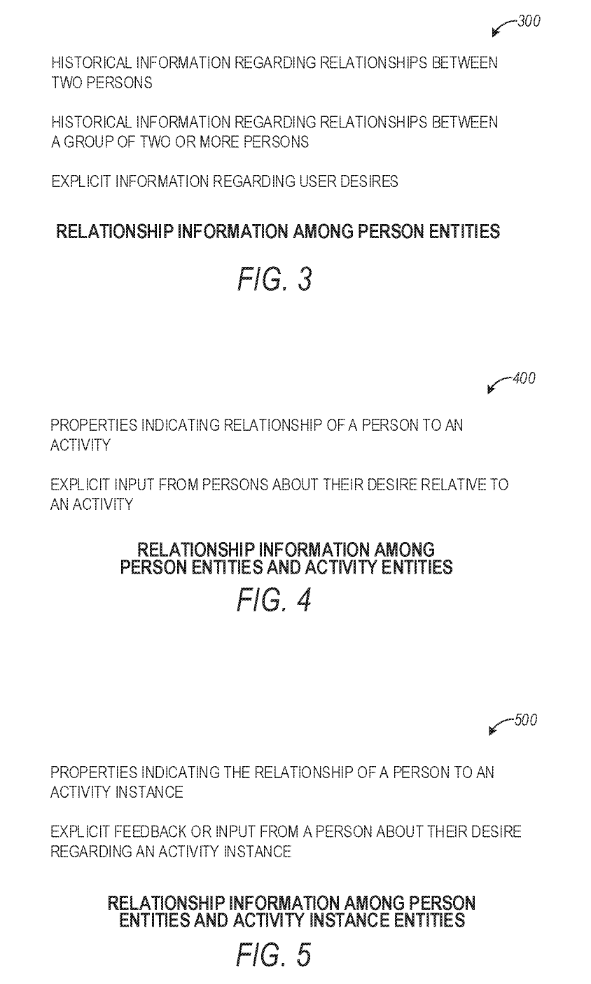

Referring now to FIG. 3, according to one example embodiment, Entity Relationships Tables 107f, or an Person←→Person Edge 150 among Person Nodes 120, includes information 300, including historical information regarding relationships between two persons, related to one or more of:
the frequency with which persons meet,
the day, week, and/or times persons tend to meet,
the frequency of activities persons have shared in the past, and
the frequency of activity instances persons have shared in the past.
   For another example, the Entity Relationships Tables 107f or edges connecting a group of two or more Person Nodes 120 include one or more of the following types of information about the group of persons:
a frequency with which the group meets.
a day, week, and/or times the group tends to meet,
a frequency of activities the group has shared in the past, and
a frequency of activity instances the group has shared in the past.

Entity Relationships Tables 107f or an Person←→Person Edge 150 may further include “explicit” information 300 obtained from a person relating to user desires, including one or more of:
an explicit meeting frequency property specifying a desired meeting frequency between persons,
an explicit meeting times property specifying desired meeting times between the persons,
an explicit meeting activity property specifying a desired meeting activity between the persons, and
an explicit meeting instances property specifying a desired meeting activity instance between the persons, and/or
an explicit activity or task instance property specifying a desired frequency or times for an activity or task, respectively.
   For example, explicit input might include “sync up with Lars at least once a week”, “file my taxes once a year”, “clean my gutters every Spring”, or “book a board meeting each quarter with members of the board.”

Accordingly, example embodiments of the scheduling and planning system described herein support, for example, the ability of users to set up ‘desired frequencies’ for activities and meeting persons for activities, which are optionally considered in determining scheduling and/or planning opportunities. This allows, for example, for users to set behavior changing goals for themselves. For example, according to an embodiment, users set either an explicit goal, such as “I want to work out three times a week” or “I only want to go out to eat once a week”. In another example embodiment, users set relative goals, such as “I'd like to ski more”, or “I'd like to spend more time with Mary”.

According to another example embodiment illustrated in FIG. 4, Entity Relationships Tables 107f and an Person←→Activity Edge 160 includes properties 400 about a relationship between a person and an activity and indicate a connection of a person to the activity and include one or more of:
a count of times a person has participated in an activity,
a frequency with which a person has participated in an activity,
a calculated relative count and frequency with respect to other activities persons have participated in together,
explicit feedback from persons about desired frequency for an activity, and
explicit input from persons about desired frequency for an activity.

According to still another example embodiment illustrated in FIG. 5, properties 500, stored in the Entity Relationships Tables 107f and edges among a person, activity and an activity instance, represented in Person←→Activity Edge 160 and Activity←→Activity Instance Edge 170, indicate a relationship of the person to an activity instance, and include one or more of:
a count of times a person has participated in the activity instance,
a frequency with which a person has participated in the activity instance,
a calculated relative count and frequency with respect to all other activity instances, for example relative to a parent Activity Node 130 of the respective Activity Instance Node 140, and
explicit feedback or input from a person about desired frequency for the respective activity instance.
   For example, the activity “eating out” may be linked to specific restaurant location or to specific types of food, the activity “skiing” may be linked to a specific ski resort or a specific location, and the activity “movies” may be linked to a specific theatre location or a specific movie genre.

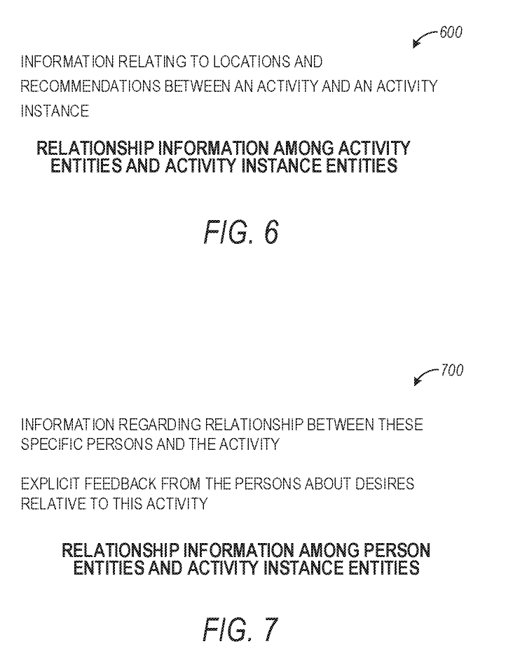

According to still another example embodiment illustrated in FIG. 6, the Entity Relationships Tables 107f and the edges connecting an Activity Node 130 and an Activity Instance Node 140 include relationships 600 including one or more of:
properties among or between an activity instance and a location for the activity instance, and
properties among or between an activity instance and recommendations related to the activity instance.

According to still another example embodiment illustrated in FIG. 7, Entity Relationships Tables 107f, and an Person←→Person Edge 150 and Person←→Activity Edge 160 between two Person Nodes 120 and an Activity Node 130 stores information about a connection between the respective two persons and the activity, wherein the relationship includes one or more of:
a count of times these specific persons have participated in the activity,
a frequency with which they have participated in the activity,
a calculated relative count and frequency with respect to all other activities these persons have participated in together, and
explicit feedback from the two persons about desired frequency for this activity.

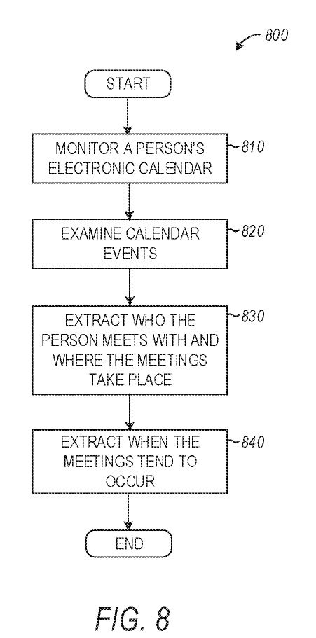

According to still more example embodiments of software applications illustrated in the flow charts of FIGS. 8 through 13, the scheduling and planning system, and in particular the automated data gathering component 241 and data transformation component 244, gather information to analyze and/or store in data store 101, and more particularly in one example embodiment, into relational data store 103 and/or graph data store 104 using one or more processes.

As shown in FIG. 8, a software implemented cloud process 800, for example performed by electronic calendar inspection component 247, monitors a person's electronic calendar 810 and examines calendar events 820 to extract who the person meets with, where the meetings take place 830, and when the meetings tend to occur 840. For example, in one example embodiment, the cloud process 800 monitors each person's electronic task list, for example from Outlook®, Wunderlist®, Trello®, or others, examines the person's tasks, who they complete them with, what their due dates are, and any other relevant constraints or properties. According to one embodiment, information is derived from the analysis of the information, and the derived information is stored in data store 101.

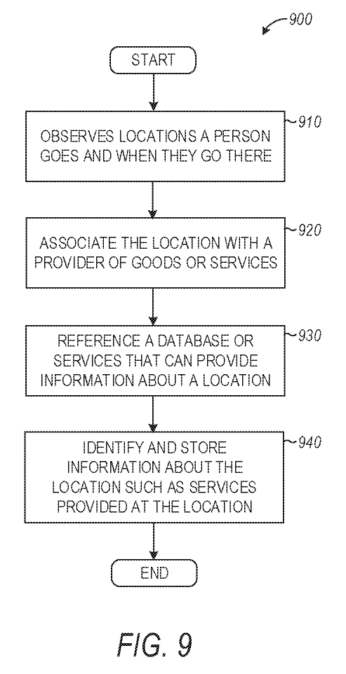

As shown in FIG. 9, a software implemented mobile application process 900, for example performed by geographic location tracking component 248, observes locations a person goes and when they go there 910, and associates the location with a provider of goods or services 920. For example, in one example embodiment, a mobile application process observes where a person goes, when they they go there and associates the location with a local business. In another example embodiment, referencing a database or services 930 that provides information about, for example, a location, the process 900 identifies and stores 940 information about the local business, such as the type of food that is served at a restaurant location, in the data store 101. According to one embodiment, the information retrieved from process 900 is stored in data store 101, or information is derived from an analysis of the information, and the derived information is stored in data store 101.

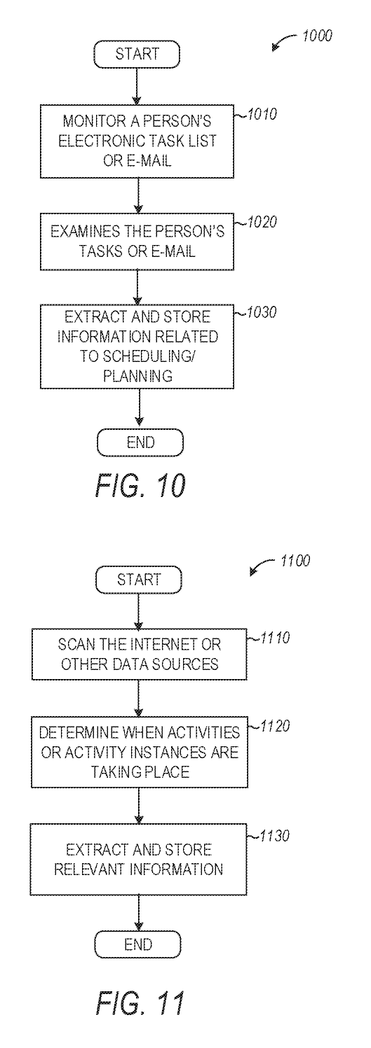

As shown in FIG. 10, a software implemented cloud process 1000, for example performed by task list or e-mail inspection component 249, monitors a person's electronic task list and/or email 1010. In one embodiment, process 1000 examines the person's tasks 1020, and in particular who they complete them with, what their due dates are, and any other relevant constraints or properties. In another example embodiment, process 1000 scans a person's email to extract topics of interest and persons that share those interests. Finally, the extracted or identified information, and/or information derived therefrom, is stored 1030 in the data store 101.

As illustrated in FIG. 11, a software implemented process 1100, for example performed by Internet events or activities inspection component 251, scans the Internet or other data sources 1110 to determine 1120 when activities or activity instances are taking place and extract and store 1130 the relevant scheduling and/or planning information, or information derived therefrom, in the data store 101. For example, in one example embodiment, there is provided a process that scans the Internet or other data sources to determine when activities are taking place, such as “band X is in Seattle”, “new Sci Fi movie is being released”, and/or “skiing conditions are good this weekend”.

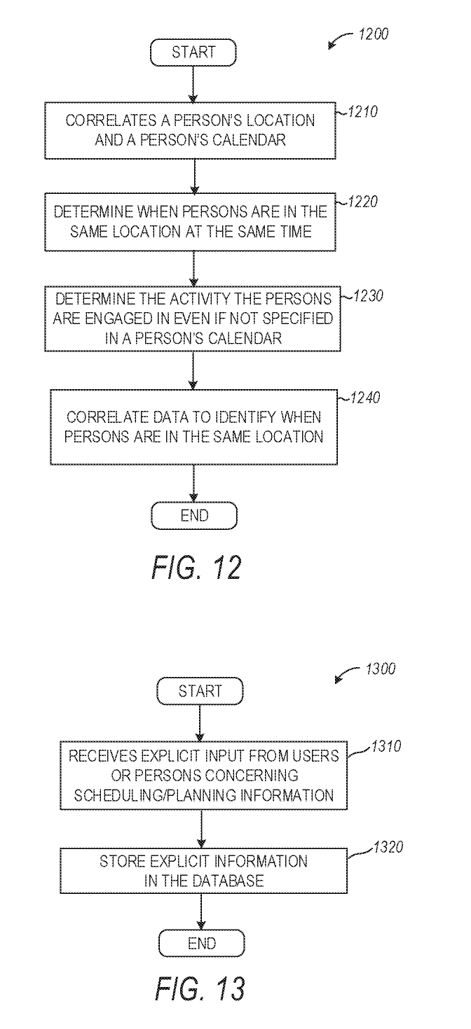

As illustrated in FIG. 12, a software implemented process 1200, for example performed by data transformation component 244, correlates a person's location and a person's calendar 1210 to determine when persons are in the same location at the same time 1220 and to determine the activity the persons are engaged in even if not specified in a person's calendar 1230. Data from these processes are correlated to identify when individuals in the graph are in the same location 1240 even when calendar events do not exist for their meeting or when the calendar does not specify the nature of the activity, such as playing golf. According to one embodiment, the information retrieved from process 1200 is stored in data store 101, or information is derived from an analysis of the information, and the derived information is stored in data store 101.

As illustrated in FIG. 13, a software implemented process 1300 receives explicit input, for example through user interface component 243, from users or persons 1310 concerning scheduling and/or planning information stored in graph data store 104, such as explicit input relating to an activity instance or a task instance, for example as described above. The process further stores 1320 this information in data store 101, and more particularly in one example embodiment, into relational data store 103 and/or graph data store 104, for example through the data store input-output component 245.

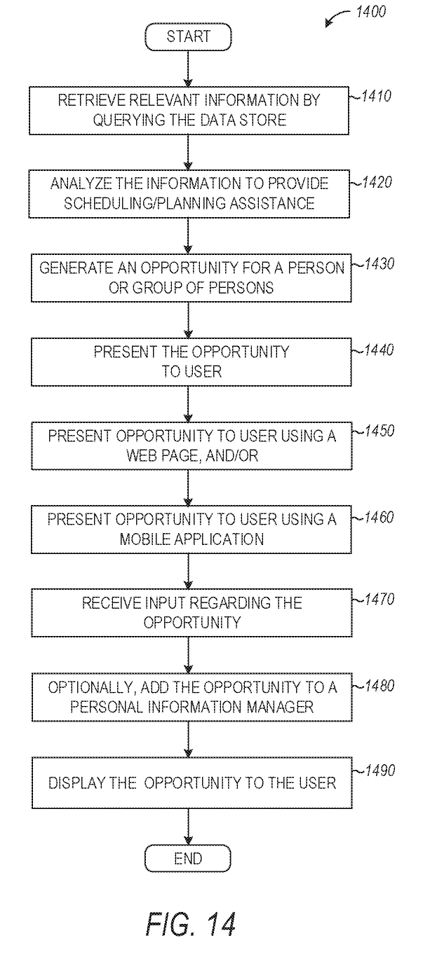

According to another example embodiment, as illustrated in the flow chart of FIG. 14, there is provided a software implemented virtual intelligent scheduling and planning assistant process 1400, for example performed by virtual scheduling and planning assistant 246, to retrieve scheduling and/or planning information by querying 1410 the data store 101 and analyze the scheduling and/or planning information 1420 to provide virtual scheduling and/or planning assistance, including generating a scheduling and/or planning opportunity for a person or group of persons 1430. According to one example embodiment, the processes 1400 is presented to the user in many forms, for example but not by way of limitation as a bot 1440, as a web page 1450, or as a mobile application 1460. These user interface options may be performed, for example, by user interface component 243. According to one embodiment, the scheduling and/or planning opportunities are thus displayed to a user in a user interface (who may or may not be a person being scheduled), wherein the scheduling and/or planning opportunity involves a person or at least one of the persons in the group of persons. Process 1400 further includes receiving input 1470 from the at least one person, received into a user interface, such as user interface 243, displaying the scheduling and/or planning opportunity, regarding the acceptability or desirability of the scheduling and/or planning opportunity. According to one example embodiment, the user interface receiving the input is controlled directly by the intelligent scheduling and/or planning application 106, or in another embodiment, the input is received into a user interface that is part of or controlled by another application such as other applications 112, and communicated to intelligent scheduling and/or planning application 106. According to another example embodiment, the process 1400 schedules the opportunity in an electronic calendar 1480, based on the scheduling and/or planning opportunity. According to one example embodiment, the electronic calendar is the electronic calendar used by a person scheduled according to the opportunity. The electronic calendar including the scheduled opportunity is then displayed 1490 to the user.

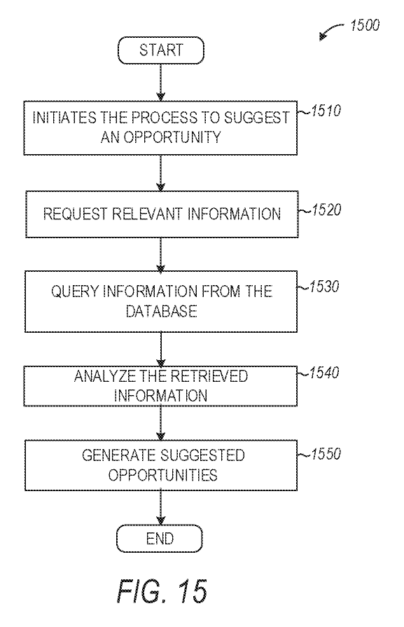

According to another example embodiment illustrated in FIG. 15, a software implemented virtual scheduling and/or planning process 1500, for example performed by virtual scheduling and planning assistant 246, provides scheduling and/or planning assistance to a user for one or more persons represented in the data store 101, for example in a Person Table 107a or a Person Node 120, in the relational data store 103 and graph data store 104, respectively. According to one embodiment, process 1500 initiates the process 1510 to suggest a scheduling and/or planning opportunity, for example either based on a request received from a user, or spontaneously in order to proactively create scheduling and/or planning opportunities. In response to a request 1520, scheduling and/or planning information is queried 1530 from data store 101, and the retrieved data is electronically processed and analyzed 1540 to generate 1550 one or more of the following suggested scheduling and/or planning opportunities: suggesting times to schedule two or more persons for an activity based at least in part on examining information from the relationship tables of FIG. 1B, or edges of FIG. 1C. In the case of examining edges in the graph data store 104, process 1500 examines one or more Person←→Person Edges 150, suggesting activities or activity instances that a person may want to participate in, based on a connection specified by properties stored by Person←→Activity Edge 160 and Activity←→Activity Instance Edge 170, suggesting a person to engage in an activity of interest with, by examining a connection a person has to the activity of interest as specified by properties stored by an Person←→Activity Edge 160, setting goals based on a desired frequency at which a person wants to perform an activity by examining a property of an Person←→Activity Edge 160, proactively suggesting persons, activities and tasks to schedule by examining a property of various edges such as Person←→Person Edges 150, Person←→Activity Edge 160, Person←→Activity Instance Edge 170 and/or Person←→Task Edge 180. Alternatively, the foregoing purposes are achieved by examining relationship information stored in the Entity Relationships Tables 107f.

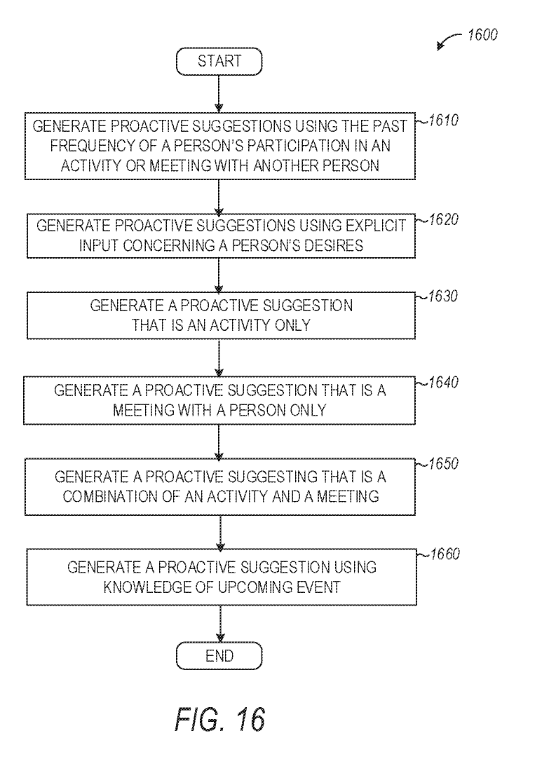

For example, according to one embodiment illustrated in FIG. 16, software implemented process 1600, for example performed by virtual scheduling and planning assistant 246, proactively suggests persons, activities, and tasks to a user. According to one embodiment, the proactive suggestions are made using the past frequency of a person's participation in an activity or meeting with another person 1610, or based on explicit input concerning a person's desires 1620. In another embodiment, the proactive suggestion may be an activity only 1630, such as “workout at 6 PM on Thursday”, or may be a meeting with a person only 1640, such as “meet with Joe on Monday at 5 PM or Tuesday at 6 PM”, or proactively suggest a combination of both, such as “consider climbing with Joe on Saturday morning” 1650. According to still another embodiment, the process 1600 may use knowledge of an upcoming event or activity to make a suggestion for a scheduling and/or planning opportunity 1660, such as “consider attending the Bjork concert on March 15^{th} with Joe, Mary or Tom, who may also be interested.”

According to one example embodiment of process 1600, the virtual scheduling and planning assistant 246 queries data store 101 and processes and/or analyzes retrieved data to determine:
free periods of time available to persons who are candidates for an opportunity to participate in an activity and/or task,
relationships among the persons who are candidates for an opportunity to participate in an activity and/or task,
type, strength, and/or frequency of activities that the persons, who are candidates for an opportunity, have a shared interest in,
activities a person likes to do, and/or the task list for a person, who are candidates for an opportunity,
upcoming events (e.g., movies and concerts), and
intentions or goals of persons who are candidates for an opportunity.

According to one example embodiment, process 1600 makes proactive suggestions for opportunities for persons to meet other persons, based on either implicit information, for example based on past meetings of persons, or explicit information, for example as specified by a person.

For an example, an implicit intention may be inferred from the fact that historical calendar information, for example stored in data store 101, shows that Rob and Allan meet regularly, such as about once every day, week, month or year. Or, alternatively, an explicit desire may be specified by a user, and stored in data store 101, such as Rob, a person, specifying “I want to meet Allan about every three months,” wherein Allan is another person represented in data store 101. For another example, the system may imply that Rob goes to the movies once a month and likes action movies, such that this becomes an explicit goal of Rob, stored in data store 101. Alternatively, in one example embodiment, Rob specifies an explicit goal to the system 100 such as “I want to go to the gym about once a week,” wherein the “go to the gym” is an activity represented in data store 101.

Accordingly, in this example, given the above implicit or explicit goals, the virtual scheduling and planning assistant 246 proactively identifies open times on a person's schedule, such as Rob's schedule in this example, when the person typically has time to do things, and makes suggestions for appointments, for example but not limited to:
proactively suggesting persons to share an activity or task with, for example: “Allan has some time in two weeks for happy hour. Should I reach out to him”,
proactively suggesting activities, such as an entertainment event, that a person may want to participate in, for example: “There's a punk concert you might like to see next week. Shall I put it only your calendar?”,
proactively suggesting combinations of persons and activities (e.g., events), for example: “Catherine is free next week for a movie, would you like me to book it?”,
proactively suggesting tasks that a person may want to perform, for example: “You have two hours free Monday morning. Should I book some time for you to write your project report?”, and
proactively suggesting tasks and other persons to perform those tasks with, for example: “Catherine and you are both free on Saturday. Do you want to schedule a house cleaning?”

In another example embodiment, the virtual scheduling and planning assistant 246, in addition to making suggestions for pairs of people and entities (tasks, events, etc), makes suggestions for groups, and determines typical group sizes, for example if a person has in the past engaged in activity with other persons, the assistant 246 makes proactive suggestions, for example but not limited to proactively suggesting who to invite based on past meeting frequency among persons (for example based on either implicitly or explicitly identified persons or frequencies), for example by:
the assistant 246, in one example embodiment, determining that a person, such as Rob in this hypothetical, typically hosts an activity, for example a dinner party, about once a month, and invites 4 to 6 of his friends, wherein the friends are other persons represented in the data store 101, and
the assistant 246 then proactively suggests to Rob that he host a dinner party at a future date consistent with the frequency of past dinner parties, and invite some or all of the friends who have been invited in the past.

In another example embodiment, the virtual scheduling and planning assistant 246 discovers shared interests for pairs of persons or for groups, for example but not limited to:
the assistant 246, in one example embodiment, determines that two persons (or more persons), for example Allan and Rob, meet once a month for an activity, such as happy hour,
the assistant 246 then determines that these same two persons (or more persons) also share an interest in another activity, for example are both avid skiers, but they've never participated together in this shared interest, for example never been skiing together, and
in this example, assistant 246 thus proactively suggests that these two (or more) persons consider participating together in the other activity in which they share an interest, for example, in this hypothetical, to go skiing together.

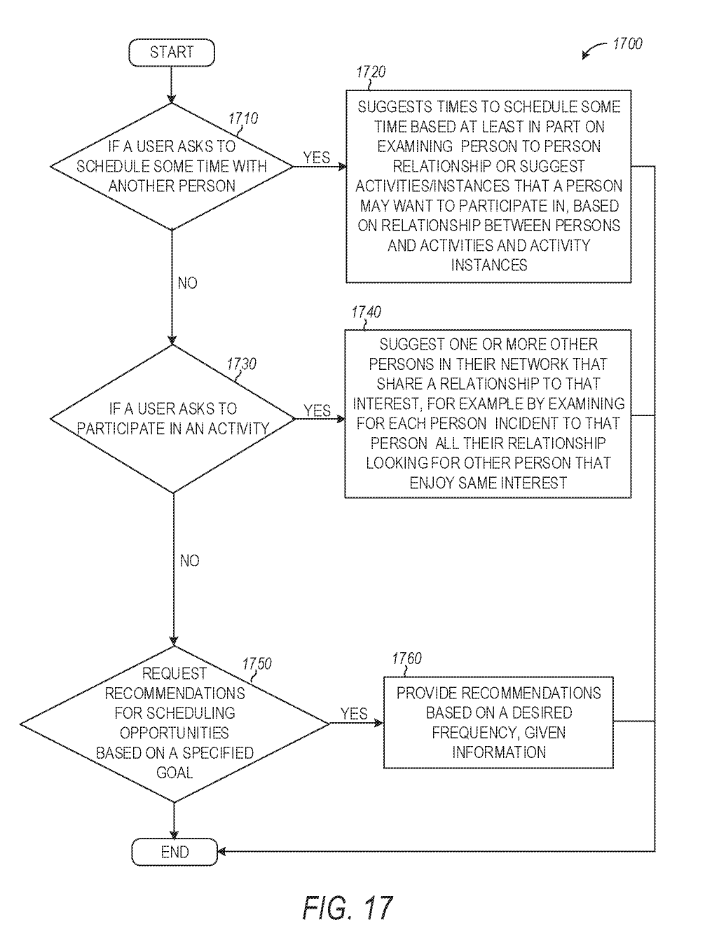

Referring now to FIG. 17, there is shown example embodiments of a software implemented virtual scheduling and planning assistant process 1700, for example performed by virtual scheduling and planning assistant 246, that responds to various different types or requests. For example, when a user asks to schedule some time with another person 1710, process 1700 suggests times to schedule some time based on at least in part examining data 1720 in one or more Entity Relationships Tables 107f of relational data store 103, or in the case of the graph data store, on a person to person edge (Person←→Person) corresponding to the person and the another person. Further, process 1700 suggests activities/instances that a person may want to participate in 1730 based on information in Entity Relationships Tables 107f, or in the case of graph data store 104, node connectivity between persons and activities and activity instances, for example by examining the properties stored on an Person←→Person←→Activity edge. For this purpose, both activities the two persons share, and also ones they both have a strong relationship or connection to, but may have never shared, are identified. According to another request type, if a user asks 1730 to participate in an activity, for example climbing, process 1700 determines and suggests one or more other persons in their network that share a relationship to that interest 1740, for example a strong connection to that interest, for example by examining 1750 for each Person Node 120 incident to that person (e.g. their friends), by examining all their Person←→Activity properties looking for other person that enjoy climbing, or alternatively examining the Entity Relationships Tables 107f to determine the same information, in the case of relational data store 103. According to one embodiment, process 1700 prioritizes persons suggested for the activity, taking into account typical time(s) and frequency the persons engage in the activity. According to another example embodiment, a user requests 1750 the process 1700 to make recommendations for scheduling and/or planning opportunities based on a specified goal 1770, and process 1700 in turn provides these recommendations 1760.

According to another example embodiment, there is described below some simple edge examples for storing relationship information between two node entities.
Example edge: Person←→Person
   Store information about relationship between two people (persons):
      Frequency with which they meet
      Day or week/times they tend to meet
      Frequency of activities they have shared in the past
      Frequency of instances they have shared in the past
      Optionally explicit value provided by individual including:
         Desired meeting frequency
         Desired meeting times
         Desired meeting Activities and Instances
Example edge: Person←→Activity
   Stores information about a connection between person and activity
   Properties of a relationship include:
      Count of times person has participated in the activity
      Frequency with which they have participated in the activity
      Calculated relative count and frequency with respect to all other activities
      Explicit feedback from person about desired frequency for this activity
         Person may want to change their habits (i.e. “go to bars less”, “go skiing more”).
         This lets the scheduling and planning system described herein be more than just observational, and helps them change their habits
Example edge: Activity←→Activity Instance
   Edges specific instances for an activity. For example:
      Eating Out→Specific restaurant locations
      Eating Out→Types of food
      Skiing→Specific ski resorts/location
      Movies→Theatre locations
      Movies→Movie genres
   Properties of a relationship include:
      Count of times anyone has participated in the Instance
      Frequency with which anyone has participated in the Instance, relative to others
      Calculated relative count and frequency with respect to all other instances relative to the parent node
      Explicit feedback from all people about desired frequency for this Instance

According to another example embodiment, there is illustrated below some simple hyper-edge examples for storying relationship information between more than two node entities.
Example edge: Person←→Person←→Person
   Store information about relationship between this group of three people:
      Frequency with which they meet
      Day or week/times they tend to meet
      Frequency of Activities they have shared in the past
      Frequency of Instances they have shared in the past
      Optionally explicit value provided by individual including:
         Desired meeting frequency
         Desired meeting times
         Desired meeting Activities and Instances
Example edge: Person←→Person←→Activity
   Stores information about a connection between these two persons and the activity
   Properties of a relationship include:
      Count of times these specific persons have participated in the activity
      Frequency with which they have participated in the activity
      Calculated relative count and frequency with respect to all other activities these Persons have participated in together
      Explicit feedback from the two Persons about desired frequency for this Activity
         Persons may indicate want to change their habits (i.e. “go to bars less”, “go skiing more”).
         This lets the scheduling and planning system described herein be more than just observational, and helps them change their habits
Example edge: Person←→Activity←→Instance
   Edges for specific instances for an activity. For example:
      Eating Out→Specific restaurant locations
      Eating Out→Types of food
      Skiing→Specific ski resorts/location
      Movies→Theatre locations
      Movies→Movie genres
   Properties/information about a relationship include:
      Count of times person has participated in the Instance
      Frequency with which they have participated in the Instance
      Calculated relative count and frequency with respect to all other instances relative to the parent node
      Explicit feedback from person about desired frequency for this Instance

According to still other example embodiments, there is set forth below examples of the operation of a virtual assistant to execute the process 1400 wherein, as noted above, the virtual assistant is presented to the user in one or more different forms such as a bot, as a web page, as a mobile application.

According to this example embodiment, the virtual assistant will provide the following capabilities:
Example—When user asks to schedule some time with another person or group of persons:
   Suggest times that are appropriate based on looking at openings on both (or three or more) user's calendars as well as historical data on when they usually meet (e.g. by examining the attributes stored on the Person←→Person edge), and
   Suggest activities/instances that they may want to participate in based on the node connectivity relationship, for example the strength of a relationship. (e.g. by examining the attributes stored on the Person←→Person←→Activity edge).
      Both activities the two users share, but also ones they both have strong connections to but may have never shared.
Example: When user asks to participate in an activity (e.g. climbing):
   Suggests other people in their network that share strong connections to that interest (e.g. by examining for each Person Node 120 incident to that person (i.e. their friends), examining all their Person←→Activity attributes looking for other people that enjoy climbing), and
   Prioritizes people, taking account typical time and frequency.
Example: When a user wants to set goals:
   Users use the personal assistant to set goals, which are represented as a desired frequency which they want to perform a given attribute of a hyper-edge in data store 104:
      “Sync up with Lars at least once a week.”
      “File my taxes once a year.”
      “Clean my gutters every Spring.”
      “Book a board meeting each quarter with members of the board.”
Example: Proactively suggests people, tasks, and activities to user:
   Using past frequency, proactively suggests activities and people to the user:
      Just an activity: “workout at 6 pm on Thursday”
      Just a person—“set up some time with Joe” with candidate times
      Combination of both—“consider climbing with Joe Saturday morning”
   Using knowledge of upcoming Event and Activities:
      “Bjork concert on March 15, Persons x, y, z may also be interested”

According to another example embodiment of the examples immediately above, unless otherwise instructed the recommendations provided by the virtual assistant will be entirely determined by historical data of the participants. However as noted hereinabove, the virtual assistant will also support the ability of users to set up ‘desired frequencies’ for activities and persons which will be considered in the calculations above. This allows users to set behavior changing goals for themselves.

According to still another example embodiment, the system 100 described herein is used more generally to gather, transform, store and use information other than scheduling and/or planning information, in order to provide intelligent assistant services. In one example embodiment, the other information is information related to a specific topic, and entities include persons with a relationship to the topic and categories of the topic, relationships include the relationships among the persons and categories, and the intelligent assistance is provided to propose opportunities to connect persons with each other and categories of interest.

FIG. 18 illustrates a block diagram 1800 of hardware and functional components of a client computing system 1810 and a server computing system 1840 to implement the system 100 and the various processes and computer programs associated therewith, such as are accomplished with the examples described above. It will be understood, that although certain hardware and functional components are depicted in FIG. 18 and in other drawings as separate systems or services, the features of the components may be integrated into a single system or service. Further, although only one client computing system and one server computing system is configured, it will be understood that the features of these systems may be distributed among one or multiple computing systems (including in cloud-based processing settings).

As shown, the client computing system 1810 includes processing circuitry 1811 (e.g., a CPU) and a memory 1812 (e.g., volatile or non-volatile memory) used to perform electronic operations (e.g., via instructions) for performing the user interface, data analysis, data gathering and/or other software implemented processes described above, for example intelligent scheduling and planning application 106 or application(s) 112, e.g., to implement the techniques depicted in FIGS. 2A-2E and 8-17, or hosting all or part of the graph data store 104 and execution of the subject software applications, for example application 106; data storage 1813 to store data included in or fetched from the graph data store 104 and computer instructions of the software applications, communication circuitry 1814 to communicate with an external network or devices via wired or wireless networking components for the scheduling and planning operations, an input device 1815 (e.g., an alphanumeric, point-based, tactile, audio input device) to receive input from a human user; and an output device 1816 (e.g., visual, acoustic, haptic output device) to provide output to the human user.

In an example, the client computing system 1810 is adapted to execute the subject software applications, through software application processing components or functionality 1820 (e.g., circuitry or software instructions). Although FIG. 18 depicts the execution of the software applications, and in particular intelligent scheduling and planning application 106 and application(s) 112, occurring on the client computing system 1810, it will be understood that application 106 and 112 may be executed on other computing systems, including multiple computing systems as orchestrated in a server-based deployment of software from the server computing system 1840.

As shown, the server computing system 1840 includes software application processing components or functionality 1848, and further includes processing circuitry 1843 (e.g., a CPU) and a memory 1845 (e.g., volatile or non-volatile memory) to perform electronic operations (e.g., via instructions) in accordance with the software applications executed therein, including intelligent scheduling and planning application 106 or application(s) 112, for example for example to generate queries or recommendations (e.g., to implement the techniques depicted in FIGS. 2A-2E and 8-17); data storage 1849 to store instructions, data included in or retrieved from graph data store 104 and other data for operation and use of the scheduling and planning system as described in above in various embodiments; and communication circuitry 1846 to communicate with an external network or devices via wired or wireless networking components for scheduling and planning operations. Other aspects may be performed by the server computing system 1840 to implement the techniques discussed herein in a server-coordinated or server-controlled environment.

FIG. 19 is a block diagram illustrating components of a machine 1900, according to some example implementations, able to read instructions from a machine-readable medium (e.g., a machine-readable storage medium) and perform any one or more of the methodologies discussed herein. More particularly, machine 1900, in an example embodiment, is used to provide the computing system capabilities referred to above with respect to the client computing system 1810 and/or server computing system 1810. Specifically, FIG. 19 shows a diagrammatic representation of the machine 1900 in the example form of a computer system, within which instructions 1916 (e.g., software, a program, an application, an applet, an app, or other executable code, as described hereinabove, for example, with respect to the various processes and software components) for causing the machine 1900 to perform any one or more of the methodologies discussed herein can be executed. The instructions 1916 transform the general, non-programmed machine into a particular machine programmed to carry out the described and illustrated functions in the manner described. In alternative implementations, the machine 1900 operates as a standalone device or can be coupled (e.g., networked) to other machines. In a networked deployment, the machine 1900 can operate in the capacity of a server machine or a client machine in a server-client network environment, or as a peer machine in a peer-to-peer (or distributed) network environment. The machine 1900 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1916, sequentially or otherwise, that specify actions to be taken by the machine 1900. Further, while only a single machine 1900 is illustrated, the term “machine” shall also be taken to include a collection of machines 1900 that individually or jointly execute the instructions 1916 to perform any one or more of the methodologies discussed herein.

The machine 1900 can include processors 1910, memory/storage 1930, and I/O components 1950, which can be configured to communicate with each other such as via a bus 1902. In an example implementation, the processors 1910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1912 and a processor 1914 that can execute the instructions 1916. The term “processor” is intended to include multi-core processors that can comprise two or more independent processors (sometimes referred to as “cores”) that can execute instructions contemporaneously. Although FIG. 19 shows multiple processors 1910, the machine 1900 can include a single processor with a single core, a single processor with multiple cores (e.g., a multi-core processor), multiple processors with a single core, multiple processors with multiples cores, or any combination thereof.

The memory/storage 1930 can include a memory 1932, such as a main memory, or other memory storage, and a storage unit 1936, both accessible to the processors 1910 such as via the bus 1902. The storage unit 1936 and memory 1932 store the instructions 1916 embodying any one or more of the methodologies or functions described herein. The instructions 1916 can also reside, completely or partially, within the memory 1932, within the storage unit 1936, within at least one of the processors 1910 (e.g., within the processor's cache memory), or any suitable combination thereof, during execution thereof by the machine 1900. Accordingly, the memory 1932, the storage unit 1936, and the memory of the processors 1910 are examples of machine-readable media.

As used herein, “machine-readable medium” means a device able to store instructions (e.g., instructions 1916) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1916. The term “machine-readable medium” shall also be taken to include any medium, or combination of multiple media, that is capable of storing instructions (e.g., instructions 1916) for execution by a machine (e.g., machine 1900), such that the instructions, when executed by one or more processors of the machine (e.g., processors 1910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1950 can include a wide variety of components to receive input, provide output, produce output, transmit information, exchange information, capture measurements, and so on. The specific I/O components 1950 that are included in a particular machine will depend on the type of machine. For example, portable machines such as mobile phones will likely include a touch input device or other such input mechanisms, while a headless server machine will likely not include such a touch input device. It will be appreciated that the I/O components 1950 can include many other components that are not shown in FIG. 19. The I/O components 1950 are grouped according to functionality merely for simplifying the following discussion and the grouping is in no way limiting. In various example implementations, the I/O components 1950 can include output components 1952 and input components 1954. The output components 1952 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1954 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1950 can include biometric components 1956, motion components 1958, environmental components 1960, or position components 1962, among a wide array of other components. For example, the biometric components 1956 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1958 can include acceleration sensor components (e.g., accelerometer), gravitation sensor components, rotation sensor components (e.g., gyroscope), and so forth. The environmental components 1960 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1962 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1950 can include communication components 1964 operable to couple the machine 1900 to a network 1980 or devices 1970 via a coupling 1982 and a coupling 1972, respectively. For example, the communication components 1964 can include a network interface component or other suitable device to interface with the network 1980. In further examples, the communication components 1964 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1970 can be another machine or any of a wide variety of peripheral devices (e.g., a peripheral device coupled via a USB).

Moreover, the communication components 1964 can detect identifiers or include components operable to detect identifiers. For example, the communication components 1964 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1964, such as location via Internet Protocol (IP) geolocation, location via Wi-Fi® signal triangulation, location via detecting an NFC beacon signal that can indicate a particular location, and so forth.

In various example implementations, one or more portions of the network 1980 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1980 or a portion of the network 1980 can include a wireless or cellular network and the coupling 1982 can be a Code Division Multiple Access (CDMA) connection, a Global System for Mobile communications (GSM) connection, or another type of cellular or wireless coupling. In this example, the coupling 1982 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1916 can be transmitted or received over the network 1980 using a transmission medium via a network interface device (e.g., a network interface component included in the communication components 1964) and utilizing any one of a number of well-known transfer protocols (e.g., HTTP). Similarly, the instructions 1916 can be transmitted or received using a transmission medium via the coupling 1972 (e.g., a peer-to-peer coupling) to the devices 1970. The term “transmission medium” shall be taken to include any intangible medium that is capable of storing, encoding, or carrying the instructions 1916 for execution by the machine 1900, and includes digital or analog communications signals or other intangible media to facilitate communication of such software. As referenced above, the embodiments of the presently described electronic operations may be provided in machine or device (e.g., apparatus), method (e.g., process), or computer- or machine-readable medium (e.g., article of manufacture or apparatus) forms. For example, embodiments may be implemented as instructions stored on a machine-readable storage medium, which may be read and executed by a processor to perform the operations described herein. A machine-readable medium may include any non-transitory mechanism for storing information in a form readable by a machine (e.g., a computer). A machine-readable medium may include a single medium or multiple media (e.g., a centralized or distributed database, and/or associated caches and servers) that store the one or more instructions.

A machine-readable medium may include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. A machine-readable medium shall be understood to include, but not be limited to, solid-state memories, optical and magnetic media, and other forms of storage devices. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and optical disks. The instructions may further be transmitted or received over a communications network using a transmission medium (e.g., via a network interface device utilizing any one of a number of transfer protocols.

Although the present examples refer to various forms of cloud services and infrastructure service networks, it will be understood that may respective services, systems, and devices may be communicatively coupled via various types of communication networks. Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A, or other personal area, local area, or wide area networks).

Embodiments used to facilitate and perform the electronic operations described herein may be implemented in one or a combination of hardware, firmware, and software. The functional units or capabilities described in this specification may have been referred to or labeled as components, processing functions, or modules, in order to more particularly emphasize their implementation independence. Such components may be embodied by any number of software or hardware forms. For example, a component or module may be implemented as a hardware circuit comprising custom circuitry or off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. The executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as the command and control service) may take place on a different processing system (e.g., in a computer in a cloud-hosted data center), than that in which the code is deployed (e.g., in a test computing environment). Similarly, operational data may be included within respective components or modules, and may be embodied in any suitable form and organized within any suitable type of data structure. The operational data may be collected as a single data set, or may be distributed over different locations including over different storage devices.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

1. A computer-implemented method, comprising:
storing scheduling and/or planning information in a graph data store, wherein nodes of the graph data store include information representing entities including persons, activities, and activity instances, and edges of the graph data store include information representing relationships among persons, activities, and activity instances;
querying the nodes and edges of the graph data store to retrieve scheduling and/or planning information representative of relationships among the persons, activities, and/or activity instances; and
electronically processing and analyzing scheduling and/or planning information retrieved from the graph data store to generate a scheduling and/or planning opportunity for a person or group of persons.

2. A method according to claim 1 wherein the graph data store includes a set of nodes N={v1, v2, . . . , vn} and a set of edges E={e1, e2, . . . , em} where each e in E can connect more than two nodes.

3. A computer-implemented method according to claim 2 further including:
automatically analyzing the scheduling and/or planning information to provide virtual scheduling and/or planning assistance including a scheduling and/or planning opportunity for a person or group of persons;
communicating the scheduling and/or planning opportunity; and
receiving input regarding the scheduling and/or planning opportunity.

4. A computer-implemented method according to claim 3 further wherein:
person nodes include information about a person;
activity nodes include information about an activity;
activity instance nodes include information about an activity instance;
an edge among person nodes includes information about a relationship between persons identified by respective person nodes;
an edge among person nodes and activity nodes includes information about relationship between persons and an activities represented by the respective person nodes and respective activity nodes; and
an edge among an activity node and an activity instance node includes information about the relationship of an activity and an activity instance represented by the respective activity node and the respective activity instance node.

5. A method according to claim 4 further including location nodes including information representing respective location entities, wherein at least one activity instance occurs at a location, and further including a plurality of edges among location entities and activity instance entities storing information relating to the relationship of location entities to activity instance entities.

6. A method according to claim 5 further including a plurality of task nodes representing respective task entities, and further including a plurality of edges among task nodes and person nodes storing information relating to the relationship of a task entity to a person entity.

7. A computer-implemented method according to claim 6 wherein at least some of the edges of the graph data store include information about a group of persons including one or more of:
a frequency with which the group meets;
a day, week, and/or times the group tends to meet;
a frequency of activities the group has shared in the past; and
a frequency of activity instances the group has shared in the past.

8. A computer-implemented method according to claim 7 wherein the edges including information about a relationship between a person and an activity includes at least one of:
a count of times a person has participated in the activity;
a frequency with which a person has participated in the activity;
a calculated relative count and frequency with respect to other activities persons have participated in together; and
explicit preferences from persons about desired frequency for the activity.

9. A method according to claim 8 further wherein an edge among person nodes includes explicit information obtained from a person including at least one of:
explicit meeting frequency information specifying a desired meeting frequency between persons;
explicit meeting times information specifying desired meeting times between the persons;
explicit activity information specifying a desired activity between the persons; and
explicit meeting instances information specifying a desired activity instance between the persons.

10. A computer-implemented method according to claim 9 wherein the information about a relationship between a person and an activity includes at least one of:
a count of times a person has participated in an activity;
a frequency with which a person has participated in an activity;
a calculated relative count and frequency with respect to other activities persons have participated in together;
explicit feedback from persons about desired frequency for an activity; and
explicit feedback from persons about desired frequency for an activity instance.

11. A non-transitory computer-readable medium comprising instructions, which when executed by at least one processor, configure the at least processor to perform operations comprising:
storing scheduling and/or planning information in a graph data store, wherein nodes of the graph data store include information representing an entity including a person, activity, and activity instance, and edges of the graph data store include information representing relationships among persons, activities, and activity instances;
querying the nodes and edges of the graph data store to retrieve scheduling and/or planning information representative of relationships among the persons, activities, and/or activity instances; and
electronically processing and analyzing scheduling and/or planning information retrieved from the graph data store to generate a scheduling and/or planning opportunity for a person or group of persons.

12. The non-transitory computer-readable medium of claim 11, wherein the graph data store includes a set of nodes N={v1, v2, . . . , vn} and a set of edges E={e1, e2, . . . , em} where each e in E can connect more than two nodes.

13. The non-transitory computer-readable medium of claim 12, the operations further comprising:
automatically analyzing the scheduling and/or planning information to provide virtual scheduling and/or planning assistance including a scheduling and/or planning opportunity for a person or group of persons;
communicating the scheduling and/or planning opportunity; and
receiving input regarding the scheduling and/or planning opportunity.

14. The non-transitory computer-readable medium of claim 13, further wherein:
person nodes include information about a person;
activity nodes include information about an activity;
activity instance nodes include information about an activity instance;
an edge among person nodes includes information about a relationship between persons identified by respective person nodes;
an edge among person nodes and activity nodes includes information about relationship between persons and an activities represented by the respective person nodes and respective activity nodes; and
an edge among an activity node and an activity instance node includes information about the relationship of an activity and an activity instance represented by the respective activity node and the respective activity instance node.

15. The non-transitory computer-readable medium of claim 14, further wherein at least some of the edges of the graph data store include information about a group of persons including information indicative of a frequency with which the group of persons meets, a frequency of activities the group has shared in the past, and a frequency of activity instances the group has shared in the past.

16. A system comprising:
at least one processor;
a storage device comprising instructions, which when executed by at the least one processor, configure the at least processor to:
store scheduling and/or planning information in a graph data store, wherein the graph data store includes a set of nodes N={v1, v2, . . . , vn} and a set of edges E={e1, e2, . . . , em} where each e in E can connect more than two nodes, wherein the nodes of the graph data store include information representing an entity including a person, activity, and activity instance, and the edges of the graph data store include information representing relationships among persons, activities, and activity instances;
query the nodes and edges of the graph data store to retrieve scheduling and/or planning information representative of relationships among the persons, activities, and/or activity instances; and
electronically process and analyzing scheduling and/or planning information retrieved from the graph data store to generate a scheduling and/or planning opportunity for a person or group of persons.

17. The system of claim 16, wherein the at least one processor is further configured, when executing the instructions, to:
automatically analyze the scheduling and/or planning information to provide virtual scheduling and/or planning assistance including a scheduling and/or planning opportunity for a person or group of persons;
communicate the scheduling and/or planning opportunity; and
receive input regarding the scheduling and/or planning opportunity.

18. The system of claim 17, further wherein:
person nodes include information about a person;
activity nodes include information about an activity;
activity instance nodes include information about an activity instance;
an edge among person nodes includes information about a relationship between persons identified by respective person nodes;
an edge among person nodes and activity nodes includes information about relationship between persons and an activities represented by the respective person nodes and respective activity nodes; and
an edge among an activity node and an activity instance node includes information about the relationship of an activity and an activity instance represented by the respective activity node and the respective activity instance node.

19. The system of claim 18, further wherein at least some of the edges of the graph data store include information about a group of persons including information indicative of a frequency with which the group of persons meets, a frequency of activities the group has shared in the past, and a frequency of activity instances the group has shared in the past.

20. The system of claim 19, wherein the at least one processor is further configured, when executing the instructions, to:
query the graph data store to retrieve information about the relationship between persons, activities and activity instances; and
analyze the information retrieved by the query of the graph data store, to determine at least one group of persons, at least one activity that the group of persons shares an interest in, and at least one instance of the at least one activity that the group of persons shares an interest in.
